(19) United States
(12) Patent Application Publication
(10) Pub. No.: US 2004/0172280 A1
(43) Pub. Date: Sep. 2, 2004

(54) Method and system for administering digital collectible cards

(76) Inventors: Johanna Fraki, Helsinki (FI); Kimmo Hamynen, Espoo (FI); Martin Zilliacus, Kauniainen (FI)

Correspondence Address: PERMAN & GREEN, 425 POST ROAD, FAIRFIELD, CT, 06824, US

(21) Appl. No.: 10/796,706

(22) Filed: Mar. 9, 2004

Related U.S. Application Data
(62) Division of application No. 10/033,151, filed on Dec. 26, 2001.

(30) Foreign Application Priority Data
Dec. 29, 2000 (FI) 20002900

(51) Int. Cl. G06F 17/60

(52) U.S. Cl. 705/1; 705/26

(57) ABSTRACT

A method and a system for administering digital collectible cards for mobile terminals. The method comprises storing a digital collectible card on a server, associating at the server the digital collectible card with information indicating the owner of the card, accessing the server with the wireless user terminal via wireless communication, supplying identification information about the user of the wireless user terminal to the server, and transferring the digital collectible card to the wireless user terminal having identified the user as the owner of the card.

### BACKGROUND OF THE INVENTION

1. Field of the Invention

The invention relates to administering digital collectible cards or objects for mobile terminals.

2. Description of the Related Art

Collecting sports trading cards, stamps, posters, and other collectibles has long been a popular pastime. The market in these items and in these areas, especially trading cards, has expanded and become very popular. With that expansion, paper cards have become more advanced and are increasingly becoming more expensive to produce and purchase. Moreover, the after-market-value for cards has continued to increase, with prices for rare cards reaching quite amount of money.

Computers, software, databases, and the Internet based distributing, collecting and trading systems are used. User accesses the card that is under his possession by a personal computer. The card can only be accessed by the user. The user purchases a card and downloads it from a server on the Internet to the computer he is using. The cards have a photo, a sound, a visual screen, text about a particular person and topic, and games. The cards are issued in limited editions. A unique serial number for the card is displayed. Cards access the card server to download and display current information in real-time. Such a system is disclosed in publication WO 00/11827.

Advances in telecommunications systems technology have resulted in a variety of systems and services being available for system users. These systems include cellular telephone systems providing mobile telephone services. The cellular telephone systems provide services that allow subscribers to these systems to increase their accessibility and be reachable, potentially at all times, and as long as the subscribers remain in the service areas covered by their systems.

In a cellular system, a person desiring to contact the cellular subscriber would simply dial the phone number of the cellular subscriber to contact the subscriber at the subscriber's cellular telephone. As long as the cellular subscriber kept the cellular telephone powered on the subscriber would be accessible when located within the coverage area of the cellular system.

Some mobile networks include short message services, e.g. SMS is a bi-directional service in GSM for short alphanumeric messages or data in similar form. In SMS it is possible to deliver a message to the mobile terminal even during an established call, or to deliver a message using so-called store-and-forward service, in which the message is stored in the network, if the mobile terminal is unavailable, and forwarded shortly after the mobile terminal can be reached again. In the traditional GSM system data services are based on circuit switched technology providing maximum data transfer rate of 9.6 kbit/s for transparent and non-transparent bearer services for data communication. Along with an increasing data volume, demand for higher transfer rates has arisen so that the GSM has been developed to include as an extension the so-called General Packet Radio service (GPRS) as a packet switched data service.

While these trading cards and other collectibles continue to fascinate the general public, as computers, mobile phones, and the Internet become more popular, collectors are looking for more exciting and more advanced ways of collecting collectibles. The present invention provides a solution to the aforementioned and other shortcomings of the prior art, while offering additional advantages over the prior art.

### SUMMARY OF THE INVENTION

To overcome limitations in the prior art described above, and to overcome other limitations that will become apparent upon reading and understanding the present specification, the present invention discloses a system, apparatus and method for identifying a user of a mobile terminal in a communication network and associating a digital collectible object with the user of the mobile terminal. According to the invention digital collectible cards are stored on a server together with association information indicating the owner of each card. The users may view their digital collectible cards on their mobile terminals by contacting the server with their mobile terminals, providing identification information, whereby the digital collectible card(s) is transmitted to the user's mobile terminal when the identification information matches with the association information indicating the owner of the card. This provides an efficient way of administering and owning digital collectible cards for view on mobile terminals. Mobile terminals usually have limited memory and storing a plurality of digital collectible cards in the mobile terminal may thus not be feasible. With the present invention this can be avoided by storing the digital collectible cards on a server. The invention is thus very suitable for collecting digital collectible cards with a mobile terminal or other portable device with limited memory capacity.

In accordance with a first aspect of the invention there is provided a method for administering digital collectible cards in a communication network, comprising the steps of:

identifying the user of a mobile terminal in the communication network, the user entering the communication network using the mobile terminal; and

associating a digital collectible card with the user based on the identification received from the mobile terminal.

In accordance with a second aspect of the invention there is provided a method for owning a digital collectible card to be displayed on a wireless user terminal, comprising the steps of:

storing a digital collectible card on a server;

associating at the server the digital collectible card with information indicating the owner of the card;

accessing the server with the wireless user terminal via wireless communication;

supplying identification information about the user of the wireless user terminal to the server; and

transferring the digital collectible card to the wireless user terminal having identified the user as the owner of the card.

According to another embodiment of the invention, the user may trade the digital collectible card with a second user. The trading of the digital collectible card with the second user can be performed under control of a server. The trading of the digital collectible object with the second user may also include a direct transfer from first mobile terminal to second mobile terminal via a wireless communication such as a short range communication. The user may be notified of a vicinity of a second user the second user having a given digital collectible card associated. The user may also be notified of a given digital collectible card associated with a second user if the given digital collectible card is available. The communication network may determine the vicinity of the second user based on a specific location of user's mobile terminal and a specific location of second user's mobile terminal. The given digital collectible card may include a request from the user to purchase the given digital collectible card. The step of identifying the user in the communication network may include entering a password at the mobile terminal. The step of identifying the user in the communication network may also include identifying the user from identity information of the mobile terminal. The user may also transmit a request from the mobile to a server to send the digital collectible card to the mobile terminal. The digital collectible card associated with the user based on the identification may also be provided to the user. The step of providing the user with the digital collectible card may include transmitting the digital collectible card from a server to the mobile terminal via the communication network. It may also include displaying the transferred digital collectible card on the mobile terminal. The step of providing the user with the digital collectible card may include a time limit such as allowing the user to view the collectible card for a limited time in order to see the card before making a decision to purchase the digital collectible card for example. The digital collectible card is preferably a trading card, i.e. can be used for trading. The trading card may include at least one additional feature such as a streamed video, an advertisement, digital music, a video clip, and an avatar feature. The trading card may also include at least one dynamic user-specific feature. Date information of said digital collectible card may be updated in real time based on a corresponding real event of the digital collectible card. Data information of the digital collectible object may also be updated on the request of the user, the updating being based on a corresponding real event of the digital collectible card. An indicator may also be added to the digital collectible card and the indicator may include a certain price for the digital collectible card. The communication network may-include a mobile network. A server may associate the digital collectible card with the user.

In accordance with a third aspect of the invention there is provided a digital collectible card system in a communication network, comprising:

at least one mobile terminal for displaying and controlling of at least one digital collectible card associated with a user of the mobile terminal; and

a server communicating with the mobile terminal via the communication network for storing the digital collectible card and for associating the user with the digital collectible card.

Optionally, a digital physical card may wirelessly communicate with the mobile terminal for presenting independently of the mobile terminal the digital collectible card, that is transferred to the digital physical card. The communication network may include the Internet and a mobile network. The communication network may also include a GSM network. It may also include packet switched mobile communication such as GPRS and UMTS. The communication network may also include a location register to locate the mobile terminal.

In accordance with a fourth aspect of the invention there is provided a digital collectible card stored in an electronic memory and for display on a wireless mobile communication device, comprising:

first information for identifying the digital collectible card; and

second information representing a collectible object and being adapted to be displayed on a wireless mobile communication device.

Optionally, the second feature may have at least one additional feature, for example, a streamed video, an advertisement, digital music, a video, and an avatar feature.

In accordance with a fifth aspect of the invention there is provided a computer program product comprising a program of instructions executable by a computing system for administering digital collectible cards, comprising:

computer program code for identifying a user of a mobile terminal, the user entering a communication network using the mobile terminal; and

computer program code for associating a digital collectible card with the user based on the identification received from the mobile terminal.

In accordance with a sixth aspect of the invention there is provided a mobile terminal for viewing digital collectible cards, the mobile terminal comprising:

an input user interface to allow the user of the mobile terminal to input user identity information and to request a digital collectible card from the network;

a memory to store the digital collectible card received at the mobile terminal;

an output user interface to display a received digital collectible card;

a transceiver for wireless communication over the communication network; and

a processor configured to transmit user identity information to a digital collectible card server over the communication network and a request to receive a particular digital collectible card from the digital collectible card server.

For better understanding of the present invention, together with other and further objects thereof, reference is made to the following description, taken in conjunction with the accompanying drawings, and its scope will be pointed out in the appending claims.

### BRIEF DESCRIPTION OF THE DRAWINGS

In the drawings:

The method, system, terminal and the object according to the invention will be described in more detail by means of preferred embodiments, with references to the appended drawings in which:

FIG. 1 depicts a block diagram of system architecture of an embodiment of the invention where users may be associated with digital collectible cards.

FIG. 2 depicts a block diagram of a mobile terminal showing terminal components which embody the invention.

FIG. 3 illustrates a block diagram of a server embodying databases of the server.

FIG. 4 illustrates a block diagram of system architecture in embodiment of the invention where a location register may be used to locate the user.

FIG. 5 illustrates a flow chart of associating digital collectible card with the user and various possibilities to utilise the associated card.

FIG. 6 shows a process of providing the user with the digital collectible object where the digital collectible object is user specific.

FIG. 7A illustrates a block diagram of system architecture in trading the digital collectible card with user.

FIG. 7B illustrates a block diagram of system architecture in trading the digital collectible card with the user directly between users.

FIG. 8A shows an example of the menu shown in the display of the mobile terminal when user has been associated with the digital collectible card.

FIG. 8B shows an example of the notifying message shown in the display of the mobile terminal when a second user having a given digital collectible card associated is in the vicinity.

FIG. 9 illustrates a more particular embodiment where a digital physical card is connected to the mobile terminal displaying the digital collectible card.

FIG. 10 illustrates a more particular embodiment of dividing the display sections for presenting multiple digital collectible cards concurrently.

### DETAILED DESCRIPTION OF THE EMBODIMENTS

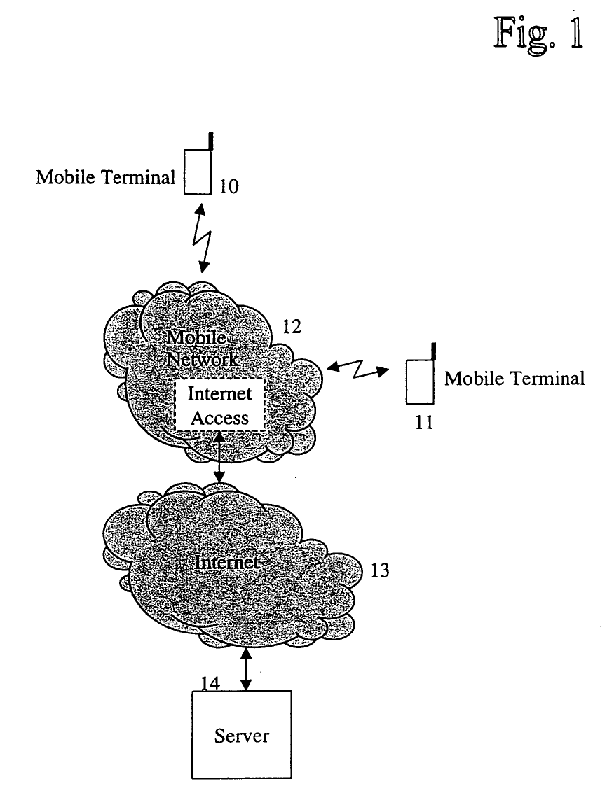

In the example of FIG. 1, a system for associating users with digital collectible cards is depicted. Users have mobile terminals 10 and 11 such as a mobile phone, a personal digital assistant (PDA), a laptop computer having a mobile connection, or any other terminal having a transceiver for wireless communication over mobile network 12. There may be several mobile terminals and users, but for illustrative purposes two is shown in FIG. 1. The mobile terminals 10 and 11 may be capable of presenting data information such as text, voice, audio, and multimedia. Mobile terminals 10 and 11 may be connected or be under coverage of at least one mobile network 12. Mobile network 12 may be any type of mobile communication network, including, but not restricted to, GSM (Global System for Mobile communication), GPRS (General Packet Radio System), UMTS (Universal Mobile Telephone System) or 3G (Third generation of mobile communications), where 3G can be compatible with GSM, HSCSD (High Speed Circuit Switched Data), GPRS, EDGE (Enhanced Data Rates for Global/GSM Evolution) and WCDMA (Wideband Code Division Multiple Access). Various other mobile networks can also be supported, such as CDMA (Code Division Multiple Access), PDC (Personal Digital Communications), CDMA2000. The mobile network 12 may alternatively be WLAN (Wireless Local Area Network).

Mobile terminals 10 and 11 may communicate with a server 14 via the communication network which may be mobile network 12 that provides access to the Internet 13. Thus, the mobile network 12 may operate as a gateway between mobile terminals (10, 11) and server 14 and it may enable mobile terminals 10 and 11 to communicate with server 14 even when the mobile network type varies. For example, the mobile network 12 may be a GPRS network and an another mobile network may be a WCDMA network (for example, mobile terminal 10 may be under coverage of GPRS network and mobile terminal 11 may be under coverage of WCDMA network). In addition to being accessed using mobile terminals 10 and 11 server 14 may also be accessed over the Internet 13 using a fixed terminal, such as a general purpose desktop computer, or a Web TV terminal. Also, although not illustrated, server 14 may be connected directly to mobile network 12 in which case mobile terminals 10 and 11 could access the server 14 without passing through the Internet 13.

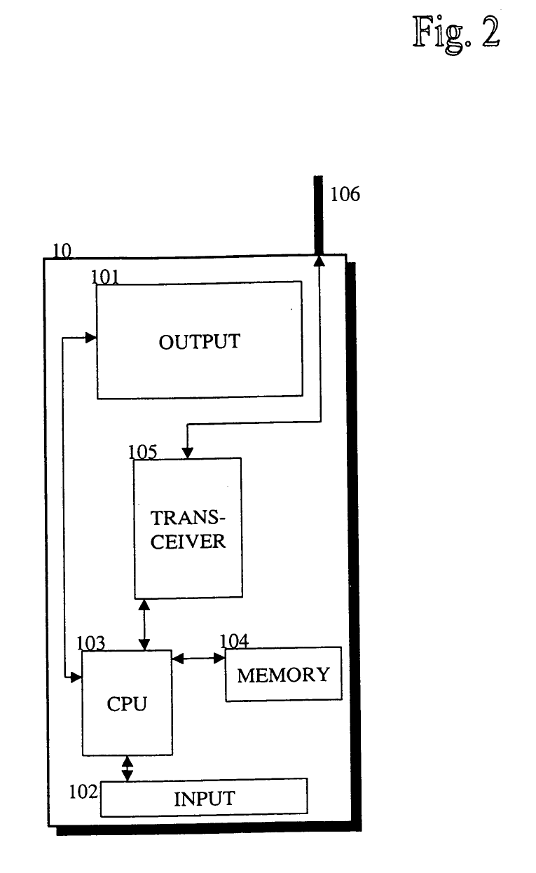

In the example of FIG. 2, a block diagram of a mobile terminal 10 is illustrated. Mobile terminal has an output 101 that allows, for example, the user to visually read information on a display. Output 101 may also provide voice or sound of the information through a loudspeaker (not shown). Output 101 may also display multimedia information such as video on the display. Mobile terminal 10 also includes a central processing unit (CPU) 103, which is connected to an input 102 and output 101, to process the information, and one or more inputs 102 for inputting the information into mobile terminal 10. Input 102 may, for example, be a numeric keypad, a keyboard, a software keyboard touch screen, a touch screen (a combination of output 101 and input), a mouse, a pointing-device such as pointing pen, etc. Mobile terminal 10 further includes a transceiver 105 that is used in communication with mobile network 12 and that is connected to CPU 103. The terminal 10 may have more than one transceiver 105. For example, one transceiver for communication with a mobile network 12 and another transceiver for short-range wireless communication such as a short-range radio communication, a Bluetooth communication. The terminal 10 also includes an antenna 106 that is connected to the transceiver 105 for transferring radio signals between mobile network 12 and transceiver 105. The mobile terminal may include more that one antenna, for example, antennae for the communication with mobile network 12 and the communication with another mobile terminal via short-range radio communication. Mobile terminal 10 also includes a memory 104 that is connected to CPU 103. Memory 104 may be used to temporarily store a digital collectible card. For example, the digital collectible card may be downloaded via antenna 106 and transceiver 105 to memory 104 by processing the data information of the downloaded card.

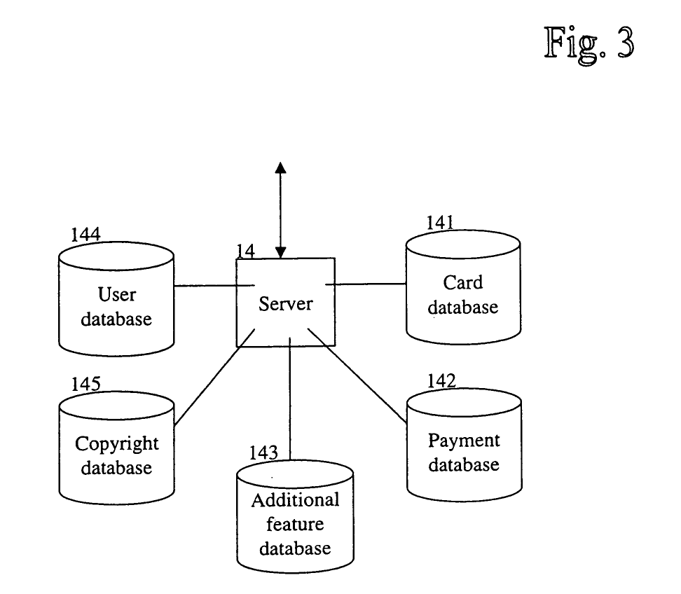

In the example of FIG. 3, a block diagram of a server 14 is depicted. Server 14 includes databases for storing and managing digital collectible cards. Server 14 may include a card database 141, which defines the card structure and hierarchy. The cards may be organized in any fashion. For example, as individual cards, as sets including one or more cards, or even portions of cards where user or server may create the card by adding different portions of a card. The cards may also be organised in user groups or user folders so that a user can easily access all the digital collectible cards that he owns and which are stored on the server. Each card may have a title and the card may be organized into sets (according to the titles). Sets may be organized into series (of cards belonging to the same series). Different series may be organized into collections of different series. There may be one or more collections per entity where the entity may, for example, be a professional sport league, a television show, a movie, etc. The card database 141 may also include statistic or performance information of the object the digital collectible card represents. For example, it may have goal statistic of the player or performance of the sport car.

The server 14 may also include a payment database 142 or also termed purchasing database. Payment database 142 may include an indicator to set a certain price for the digital collectible card. The indicator may depend on the time the user has the digital collectible card in his possession, which can be adjusted by attaching a time limit to the collectible card. It may also depend on the number of previous users that have had the card in their possession, or the previous possessor may set a certain price for the card. Payment database 142 may also include a credit card processing system, an interface with user identification payment system, mechanism for promotions, gift certificates, electronic cash, and any other network payment options.

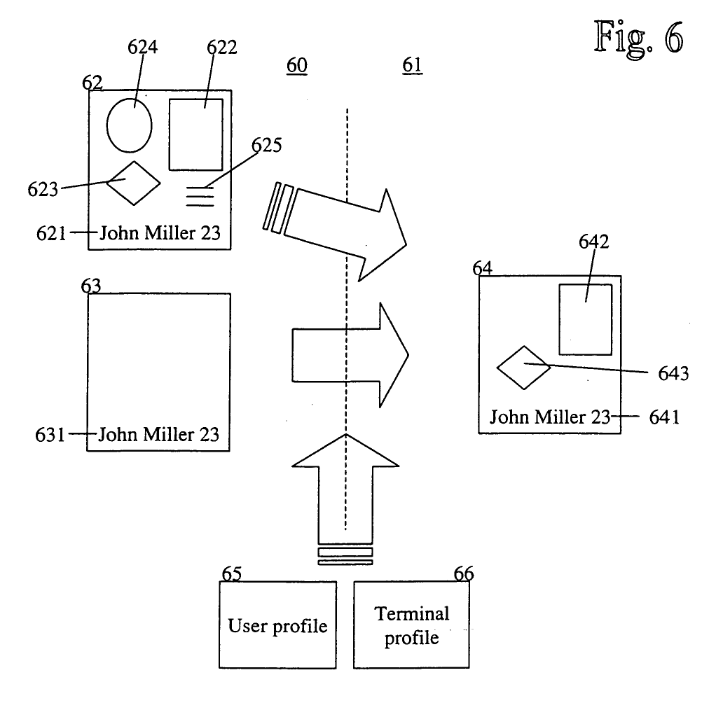

The server 14 may also include an additional feature database 143. The additional feature database 143 includes data information that may be added to the digital collectible card. For example, the additional feature may be a streamed video, an advertisement, digital music, a video clip, or an avatar feature personalizing the card to the user. The additional feature may relate to the event the digital collectible card illustrates. For example, it may be a video clip or sound of soccer player John Miller 23 (see FIG. 6) that is illustrated in digital collectible card about John Miller 23. For another example, it may relate to other information such as an advertisement that may have an effect on the price of digital collectible card. Additional feature database 143 may also include language translations to other languages than the original language that is in card database 141. This is useful when user are trading the cards internationally.

The server 14 may also include a user database 144. User database 144 may include information about the users and the cards they have received. User database 144 may be used to register the users and it may include registration information and information concerning the cards obtained by each user.

The server 14 may also include a copyright database 145. Copyright database 145 may administer copyright of digital collectible card, if it is turned on. If copyright database 145 is turned off, no administering may take place. Copyright database 145 may set control of delivery and copying of digital collectible card. Copyright database 145 may receive the user and card information from the user and card databases 144 and 141. The identification of the user and the card may be set respectively as described later. A copyright database 145 thus keeps record of number of copies of the collecible that have been delivered and thus aids in providing the copyright owner with royalty payments according to the number of delivered products.

Users communicate with the server 14 via communication network (12 and 13 in FIG. 1). The server 14 may send and receive data information to associate the digital collectible card. The databases and server 14 may also be interconnected via the Internet 13 or a local area network (LAN) or some combination thereof. The server 14 and databases (141, 142, 143, and 144) are preferably implemented as a computer program (or several programs interconnected) that is executable by a computer system and that is stored on a computer-readable program storage medium such as a on a disc or in ROM memory (hard disc) of the computer.

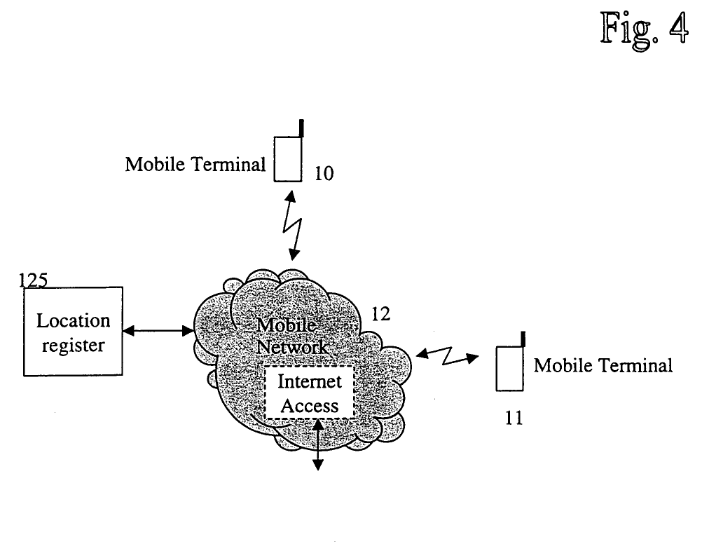

In the example of FIG. 4, an embodiment of locating the mobile terminal in communication network is illustrated. A location register 125 may be included or connected to the mobile network 12. Location register 125 may have location information of mobile terminals 10 and 11. Mobile network 12 may save the location information, that it keeps track of the locations of the mobile terminals 10 and 11, on location register 125. Location register 125 may, for example, be a Location Service Centre (LSC).

The example shown in FIG. 4 is based on locating the mobile terminal 10 in the mobile network 12 by the provision of location data of each mobile terminal. The invention does not limit the way through which such location data will be obtained. There are several known ways for locating a mobile terminal, such as those described in patent publications EP 933961 and EP 917385, which are incorporated herein by reference. Most location methods described in said patent publications are so-called OTD-methods (Observed Time Difference) or TDOA-methods (Time Difference Of Arrival) which means that either the mobile terminal or the network or both measure the arrival times and/or time difference between the arrivals of certain radio signals through at least three base stations. When the locations of the base stations and the propagation velocity of radio waves are known, it is possible to calculate the location of the mobile terminal from the observed time factors. The Location Service Center (LSC) maintains the location database in the network.

An additional applicable method for locating a mobile terminal is known from the method wherein a simple low-power transmitter, for example a Bluetooth transmitter, is installed at a known location and programmed to transmit regularly an identification signal. The transmission power of the simple transmitter is low enough and its coverage correspondingly small enough so that a mobile terminal that is able to receive its transmission may be regarded to be essentially at the same location as the simple transmitter. When the mobile terminal has received a low-power transmission from a simple transmitter, it transmits to the network a message indicative of the successful reception of the identification signal contained in the transmission. On the basis of said message the network finds out and stores the known location of the mobile terminal. If the network knows the location coordinates of the identified simple transmitter, it may inform the mobile terminal by sending a message like “you have received the transmission of the simple transmitter ABC, so you are at location XX, YY, ZZ”. Another alternative is that the simple transmitter does not transmit an identification signal but simply the coordinates of its location at a low transmission power, whereby a terminal that is able to receive its transmission may regard itself as being essentially at the indicated location.

An alternative is also that the mobile terminal includes a built-in positioning subsystem like the GPS (Global Positioning System) receivers known today. In such a case it is very straightforward for every mobile terminal to know its location, because it gets the necessary information regularly from the positioning subsystem.

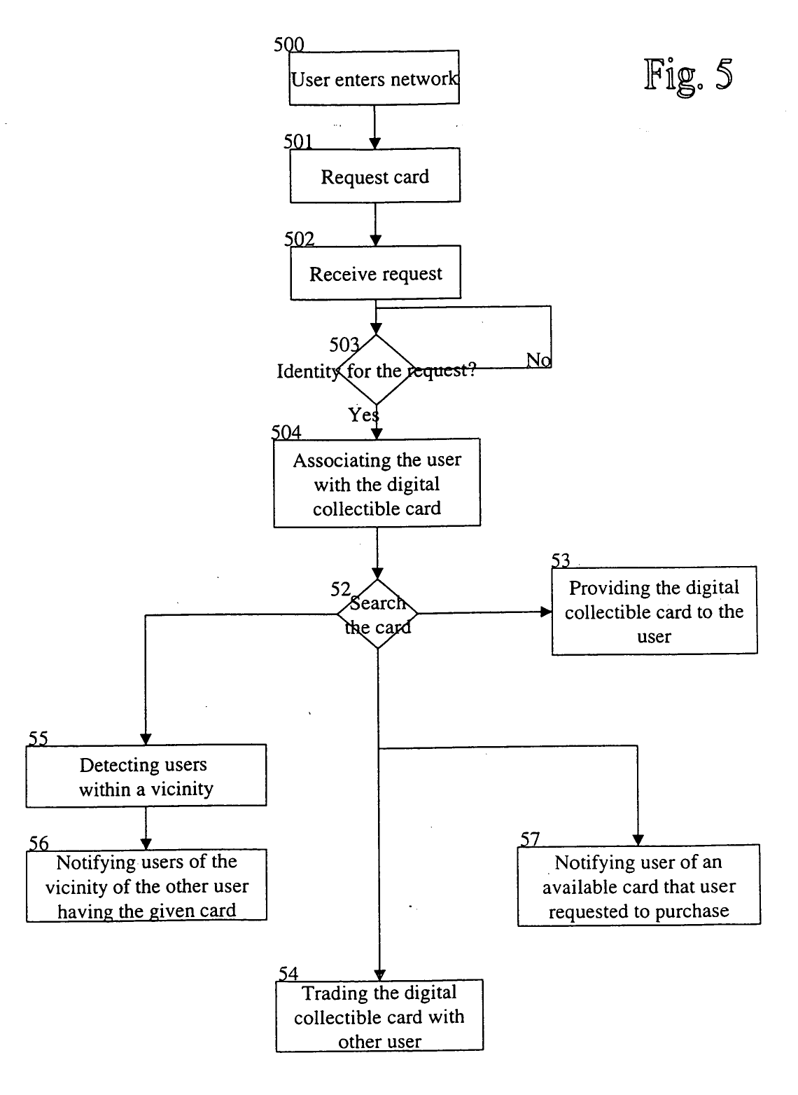

In the example of FIG. 5, a flow chart of associating a gital collectible card with the user and various possibilities to utilise the associated card is illustrated. At step 500 the user enters the communication network and, moreover, enters the digital collectible card system using mobile terminal 10. At step 501 the user requests a digital collectible card by selecting from a menu of mobile terminal 10 the possibility to access the digital collectible card. The menu is displayed on a display of mobile terminal 10. The mobile terminal 10 transmits the request to server 14 via a communication network (12 and 13). At step 502 the server 14 receives the request from the mobile terminal 10 to access to the digital collectible card. Server 14 may also inquiry and/or receive identity information of mobile terminal 10. Thus at step 503 the server 14 checks whether it has the corresponding identity information to the request. If the server has the corresponding identity information (the Yes path from step 503), for example, user's mobile terminal 10 has transmitted the identity information of mobile terminal 10 or user to server 14, server 14 processes data to associate the digital collectible card to the user based on the identity of mobile terminal 10 (step 504). If the server 14 has not received the identity information (the No path from step 503), the server 14 requests the identity of mobile terminal 10 that tries to access the digital collectible card. Server 14 continues to request the identity information unless mobile terminal 10 may substantially be unidentified. User may be identified by the network or by a separate identifying server of the trading card system.

The identification may be based only on user identification, such as a username, and a corresponding password. These both may be able to be secured by an encryption, for example over a Secure Sockets Layer (SSL) in the Internet.

The identification may also be based on terminal identification possibility. The identification may be based on to the source the user information comes from. For example, the user uses a mobile terminal that requires Personal Identification Number (PIN) identification and has some kind of Subscriber Identity Module (SIM) or equivalent possibility that the system can identify who is operating the device. Now the password to the network service system may be unnecessary because the system can identify user according to the identity information of PIN- and SIM-information. Also the International Mobile Subscriber Identification (IMSI) code may be used in identification. Thus, caller identification, relating to the phone or subscriber number (IMSI, SIM, or PIN) can be used for the identification. The identification may also require the user to enter a password together with the mobile transmitting the mobile identification.

The identification may be automatic. After a first access to the Internet the user may make actions without entering user identification and password information, or corresponding information, a second time. The security information, such as the password and user identification, may be stored only in the mobile terminal, e.g. in the terminal or in the SIM card or in other smart card attachable to the terminal. The user id and password need not be located in the network. However, the security information may also be stored in a specific network server working as, for example, a trustee server to the user, or the security information can be stored to server 14.

Returning to FIG. 5, the server 14 receives the identify information of the user and may now identify the user of mobile terminal 10. The server 14 then associates the user with the digital collectible card (step 504). The association may be based on the identification of the user's mobile terminal 10. The association may also be based on the mere identification of the user. Then at step 52 the server 14 searches the requested digital collectible card from card database 141. Server 14 may now check that the requested user is the real owner of the digital collectible card by comparing user's identify information to the user information in the database. Server 14 may also search the user information from user database 144 corresponding to the identification information it has received. User information may also, for example, comprise the preferred appearance of the digital collectible card to user that user wishes to view. Server 14 may also search additional features that may relate to the digital collectible card from additional feature database 143. Card database 141 may have listed the features that are available to the card. Additional feature database 143 may also have listed the corresponding cards the feature pertains to. After the user has been associated with the digital collectible card the user has various possibilities to utilise the associated card. In the example of FIG. 5 only some examples are listed. Having found the card (or the digital collectible object) the server 14 provides the associated digital collectible object to the user (step 53 in FIG. 5), which thus can be displayed on the display of the mobile terminal.

Referring now to the example in FIG. 6, a process of providing the digital collectible card to the user where the digital collectible card is user specific is illustrated. A server node 60, for example server 14, includes database for second features such as additional feature database 143 having additional feature tables 62. Additional feature table 62 may include a card identification field 621, a picture field 622, a video field 623, and an audio field 624. Additional feature table 62 includes also a textual information field 625 that gives, for example, statistic or performance of the object that the card represents in a specific language. The additional feature table 62 may include other fields depicting various extra features such as a field for advertisement or for an avatar.

In the field of computer technologies and Internet, the term avatar is defined as an electronic representation of a person in cyberspace. People “wear” avatars to visit and explore virtual reality (VR) spaces. People can control avatar motion and behavior in the VR space, meet other people's avatars and communicate with them. There are many sites in the Internet, which implement visual VR spaces, together with a selection of standard avatars. There are also special sites dedicated to avatar development. These sites allow user to search, look and download avatars from the databases, or place verbal order requesting creation of a new original avatar. Typically, an avatar looks like a face or figure of a human or creature. Avatars can be presented using photos, bitmaps, 3D shapes, animations and recorded sound. An avatar is “driven” by the user: it can articulate user's speech, or express emotions, or demonstrate gestures, or move around the VR space. Avatars are also useful in the Internet entertainment services, like chats or multiplayer games. Avatars add more fun to such services, because they are like carnival masks which release people from social or psychological constraints and empower imagination.

Server node 60 includes also first features such as card tables (63). Card table 63 may include a card identification field 631 that associates the user request and the possible included additional features with the card displayed to the user. A user profile 65 may also affect the card displayed to the user. User profile 65 may set dynamic user-specific features to the card. User profile 65 may include information on the user's penchants and type of the mobile terminal. These penchants may be information indicating or relating what card's features user prefers to be displayed. For example, user may like English textual information, the picture, and a video of the card's object to be displayed on the output of mobile terminal. Another user may prefer only to display the picture of the object of the card. It may also indicate the series or sets of the card such as standard, premium, and extreme series. The user profile 65 is preferably created when user registers at the server 14 for the first time, but the user can later modify the profile 65. Upon registration the user enters personal and personal liability information to server 14. The entered information may be stored to the user database 144 which may be included in server 14. New registered users may, for example, get 5 cards for free as a bonus for the registration. A terminal profile 66 may also affect the card displayed on the mobile terminal. Terminal profile 66 may have information relating to capabilities of the mobile terminal. Terminal profile 66 may include information on terminal types and models and their capabilities (size of display, memory size, processing capabilities, network capabilities, etc.). For example, if a user's mobile terminal A is broken, user's digital collectible card may be displayed on a mobile terminal B. This is because mobile terminal B receives the card that has features according to the terminal profile B. The profiles may be stored on server 14. Server 14 may also inquire them if they are stored elsewhere. The mobile terminal 10 preferably displays the digital collectible card 64 to user on its display. The digital collectible card 64 being displayed may include a textual information field 641, and also a picture 642 and/or a video clip 643 (or an advertisement, or an avatar) according to what is specified in the user profile 64 and/or terminal profile 66.

The digital collectible card may be updated according to the real event the digital collectible card represents. Server 14 may receive information about the object that the card represents. This information may be transmitted from any source in the communication network as long as it is substantially reliable and identifiable. Server 14 may now upload the information to the card database 141 or to the additional feature database 143. The updating may be an automatic process and it can happen dynamically without the user's concem. Of course the user may now get the updated information of the card. The user may also send a request to update or just to see the updated data information. The request may be sent to server 14 from mobile terminal 10 indicating server 14 to further request the possible update information the request relates to. Server 14 may now transmit the request to some communication network resource in order to get the updating. Server 14 may also already have the updating but it is not displayed to mobile terminal user until the mobile terminal user makes the request to see the updated information. For example, soccer player John Miller number 23 makes a goal in the game. The statistic information center enters the goal to statistic source of John Miller 23. The source transmits a message (in real time to server 14) indicating that John Miller 23 made a goal. Server 14 may also make queries to search the updated information from various sources. Server 14 receives the message and updated the database automatically. Server 14 may also send this statistical information to the mobile terminal user if the user has been associated to the card in question.

Returning again to FIG. 5, the user may trade the digital collectible object associated with other user (step 54). In this case the user transmits a message having a price of the digital collectible card and a new owner of the card to server 14 by mobile terminal 10. Server 14 receives the price and new owner message. Server 14 sends a request to confirm the trade to the new owner. The new owner receives the request and the new owner may accept or reject it. The new owner transmits the acceptance or rejection to server 14. If server 14 receives the rejection, server 14 cancels the transaction, or if the acceptance is not received within a reasonable time, server 14 cancels the transaction, and sends a canceling message to the user (The user who initiated the trade). If the server 14 receives the acceptance, it starts a payment process. All well known payment methods may be used (credit card, bill to phone, checks on-line, CyberWallets, e-cash, Internet payment, etc.). Payment database 142 processes the transaction and confirms the association of the card with the new owner. Payment database 142 may also include calculations for promotions, gift certificates, etc. The user who is going to buy the card may also view the card before he makes the trade acceptance for a certain period of time. For this purpose a time limit is attached to collectible card so that the user can view the card during that period but can not store it permanently in the mobile terminal. Server 14 may keep track of the time and may allocate the card to the user if the owner of the card allows this.

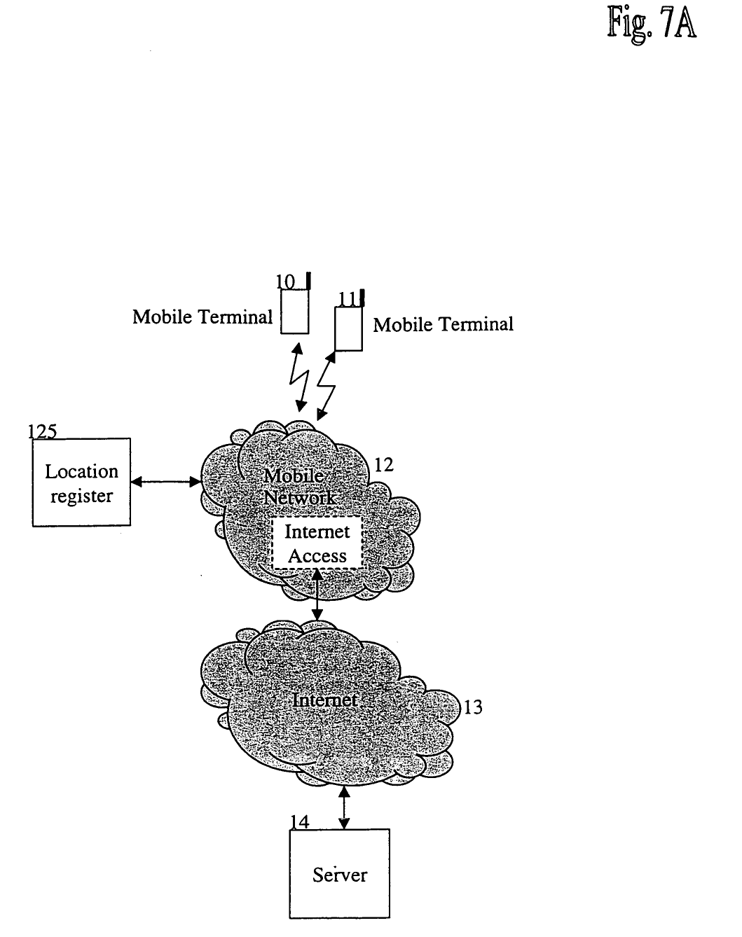

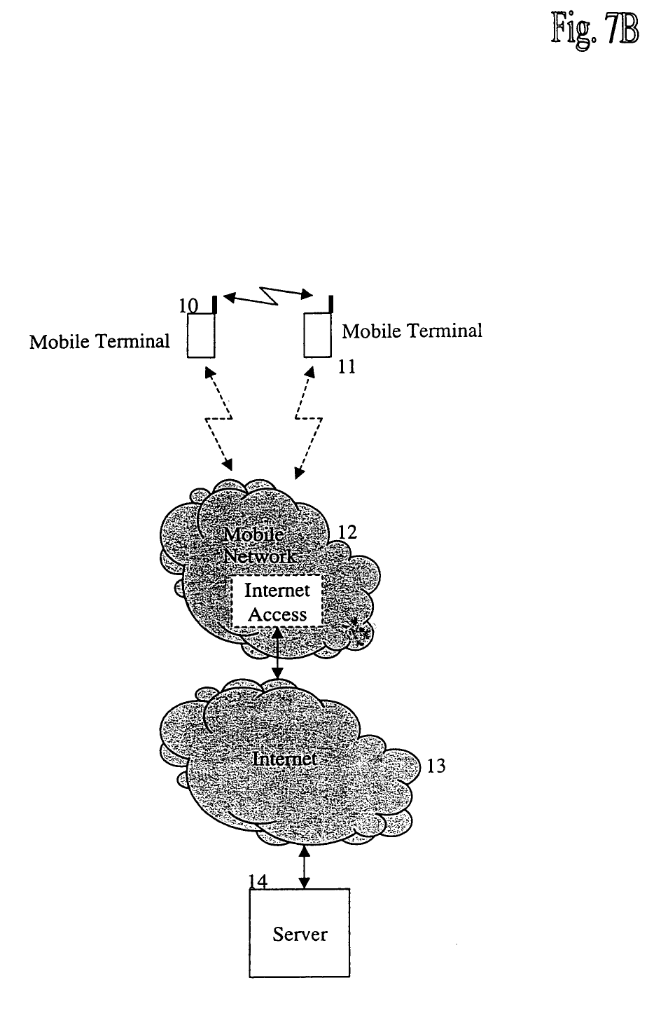

Referring to FIG. 5, the step 54 of trading the card may include the user making an offer to purchase a given card to server 14. Server 14 registers the offer and it may keep track of the associated owner of the given card. The owner of the given card may also indicate to server 14 that he is willing to sell the card although this is not necessary for the process step. User and the card's owner may be in the vicinity sometimes in real life, which can be detected e.g. using location information (step 55). The locations of the user (user's mobile terminal) are detected as stated previously referring to the locating and FIG. 4. The detected other-users-are notified of when they are in the vicinity and user has requested to purchase a card that belongs to the other user (step 56). Referring now to the situation in FIG. 7A, a communication network based notifying and possible trading is illustrated. When mobile terminals 10 and 11 are in the vicinity of each other, for example, they are in the same cell of mobile network 12, or they are otherwise in the proximity of each other and the communication network (12, 13) is able to track or detect that, server 14 sends messages to both mobile terminals 10 and 11 to indicate this. The messages may have information that suggest or proposes a meeting to trade the card or it may have information that a user who is willing to buy/sell the card is in the vicinity. Possible trading is controlled by server 14. Thus, in the situation illustrated in FIG. 7A the mobile terminals 10 and 11 transmit messages via the communication network 12 to the server 14 that may further refer back to the mobile terminals 10 and 11. Referring to the situation in FIG. 7B, a wireless communication such as a short-range radio communication based notifying and possible trading is illustrated. When mobile terminals 10 and 11 are in the vicinity (step 55 in FIG. 5), for example, within the operation range of low power radio, mobile terminals 10 and 12 detect one another and transmit directly messages between each other that propose to trade the card. Thus, users may be notified of the vicinity of each other (step 56 in FIG. 5). The messages may have information that suggests or proposes a meeting to trade the card or it may have information that a user who is willing to buy/sell the card is in the vicinity. Possible trading may now be a direct transfer between mobile terminals 10 and 11 via wireless communication such as short-range radio communication such as Bluetooth. Mobile terminals 10 and 11 may send confirmation and registration messages to server 14 via mobile network 12 and the Internet 13. Respectively server 14 may acknowledge the messages to mobile terminals 10 and 11.

Referring again back to FIG. 5, the user may be notified (at step 57) of an available card that the user has earlier requested to purchase. The user may send a request to purchase a given digital collectible card. The request may be sent to server 14. Server 14 may register the request and make an indication, for example save the info to card database 141 or payment database 142, that user is interested to buy the card. The indication may include the price of the card, time limit for the offer indicating how long the offer is valid, anonymity of the purchaser, type or model of the card such as any card relating to sport cars, etc. After given card's owner is associated with the card and the owner is willing to trade the card, user may receive a message indicating that the given card is available. Users may be located anywhere within the mobile network.

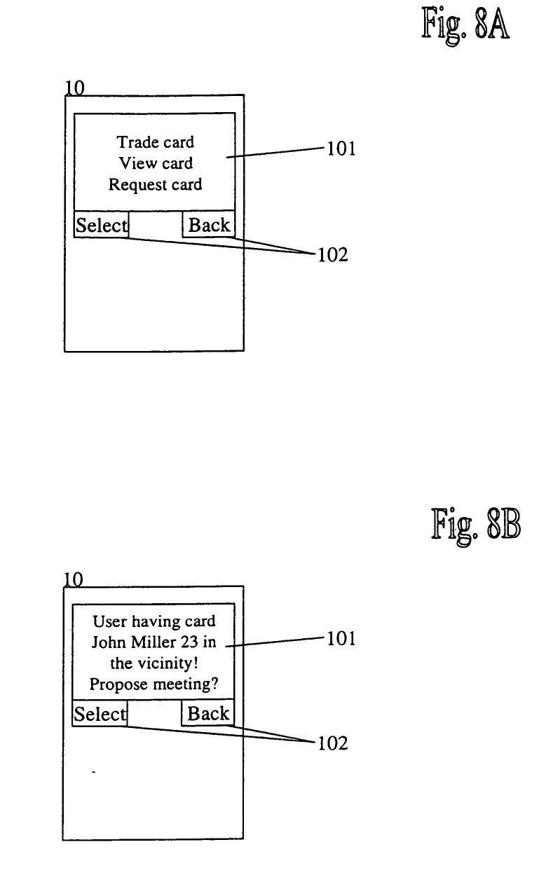

Referring now to of FIG. 8A, an example of a menu on the display 101 (indicated as output in FIG. 2) of mobile terminal 10 is shown when user has been associated with digital collectible card. The display 101 has, for example, a text menu where a “Trade card” command indicates that user wants to trade a digital collectible card. A command “View card” indicates that user wants to download and view a certain digital collectible card and command “Request card” can be used to indicate that user wants to purchase a given digital collectible card. When “Trade card” is selected in the list and user inputs via input 102, for example presses a select button, the mobile terminal 10 sends a message to the server to trade the digital collectible card. The message may be also directly sent to another mobile terminal (as illustrated in FIG. 7B). When “View card” is selected in the list and user presses select button, mobile terminal 10 sends the message to the server to download the digital collectible card. When “Request card” is selected in the list and user presses select button, mobile terminal 10 sends a message to the server indicating the user's willingness to purchase the card.

In FIG. 8B, an example of a notifying message shown on the display 101 of the mobile terminal 10 when a second user having a given digital collectible card is in the vicinity is shown. Here, the display 101 may, for example, show a text “User having card John Miller 23 in the vicinity! Propose meeting?”. User gets the text, for example, if he is in the vicinity of the owner of the card that he wishes to purchase. When user selects “Propose meeting?” by inputting via input 102, for example pressing select button, the user's mobile terminal 10 sends message to the mobile terminal of the card owner.

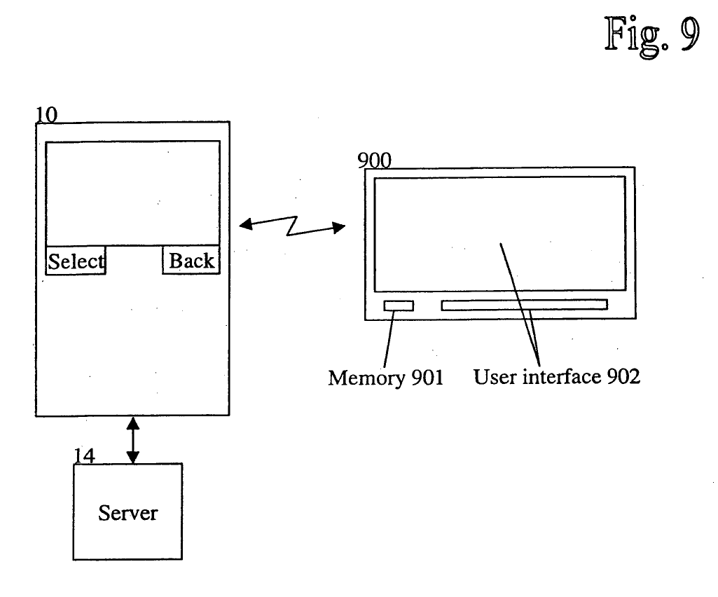

Referring to FIG. 9, there is shown an example of a digital physical card 900 that communicates with a mobile terminal 10 is illustrated. A separate digital physical card 900 that may present the digital collectible card may be used. The digital physical card 900 includes a memory 901 to store the digital collectible card downloaded to the digital physical card 900 via a short range radio communication. The digital physical card 900 includes a user interface 902 to receive information from the user (of the cared) and to present information to the user. The user interface 902 may be connected to memory 901 to store and present the digital collectible card. Digital physical card 900 may also have a processor configured to perform functions necessary to receive and present the digital collectible card. Digital physical card 900 may also have a short range radio transceiver for the communication between mobile terminal 10. Mobile terminal 10 may download the digital collectible card server 14. Mobile terminal 10 detects or the user sets that digital physical card 900 is presence. For example, the digital physical card 900 is within the operation range of a Bluetooth link. Mobile terminal 10 communicates with digital physical card 900 using the Bluetooth communication (or other short range radio or other wireless communication). Mobile terminal 10 transmits the digital collectible card to digital physical card 900 via the Bluetooth communication. Digital physical card 900 receives the card and stores it in memory 901. The user may now be presented the digital collectible card on the digital physical card 900. The user may delete the digital collectible card from digital physical card 900. Mobile terminal 10 controls the actual digital collectible card that is located at server 14.

One embodiment of establishing Bluetooth connection between mobile terminal 10 and digital physical card 900 may be the following. In order to establish new connections the procedures inquiry and paging are used. The inquiry procedure enables a unit to discover which units are in range, and what their device addresses and clocks are. With the paging procedure, an actual connection may be established. Only the Bluetooth device address is required to set up a connection. Knowledge about the clock will accelerate the setup procedure. A unit that establishes a connection will carry out a page procedure and will automatically be the master of connection. In the paging and inquiry procedures, the device access code (DAC) and the inquiry access code (IAC) are used, respectively. A unit in the page scan or inquiry scan substate correlates against these respective access codes with a matching correlator. For the paging process, several paging schemes can be applied. There is one mandatory paging scheme which has to be supported by each Bluetooth device. This mandatory scheme is used when units meet for the first time and in case the paging process directly follows the inquiry process. Two units, once connected using a mandatory paging/scanning scheme, may agree on an optional paging/scanning scheme. The above is a short description of the establishment of a Bluetooth connection, which is specified in more detail in the Bluetooth specifications. Other connectivity protocols may as well be used which may function in a different manner.

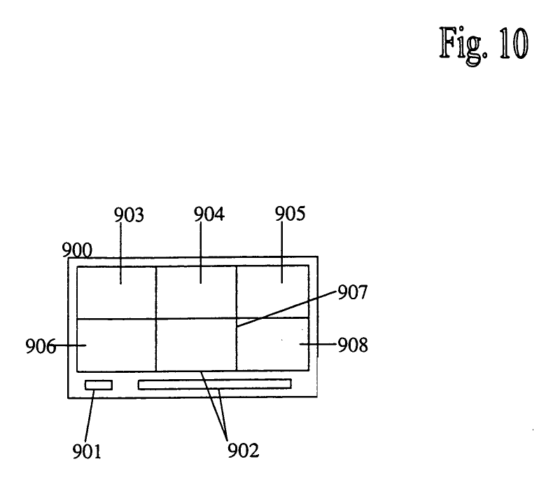

Referring now to FIG. 10, there is shown an example of dividing the display in section for presenting multiple digital collectible cards concurrently. The display of the digital physical card 900 or the display of mobile terminal 10 may be divided into parts 903-908 as illustrated in the figure. Each part 903-908 may illustrate a different digital collectible card which may be downloaded to the terminal 10 or physical card 900 in question. Each different digital collectible card may be presented in each different part respectively. For example, part 903 may display card about John Miller 23 and part 907 may present card about a sport car. The dividing of the display allows multiple digital collectible card show in one apparatus presented possibly concurrently.

While there has been described what are believed to be the preferred embodiment of the invention, those skilled in the art will recognize that other and further changes and modifications may be made thereto without departing from the spirit of the invention, and it is intended to claim all such changes and modifications as fall within true scope of the invention. For example, the digital collectible card may be encrypted and stored on SIM-card, and a key to the encryption may be downloaded from the server to the mobile that allows retrieval of the collectible card from the SIM card to be presented on the display of the terminal.

What is claimed is:

1. A method for administering digital collectible cards in a communication network, comprising the steps of:
identifying the user of a mobile terminal in the communication network, the user entering the communication network using the mobile terminal; and
associating a digital collectible card with the user based on the identification received from the mobile terminal.

2. The method of claim 1, further comprising the step of the user trading the associated digital collectible card with a second user, wherein the second user is associated with the digital collectible card after the trade.

3. The method of claim 2, wherein the step of trading the digital collectible card with the second user is performed under control of a server.

4. The method of claim 2, wherein the step of trading the digital collectible card with the second user includes storing the digital collectible card at a first mobile terminal, and transferring the digital collectible card from the first mobile terminal to a second mobile terminal via a wireless communication.

5. The method of claim 1, further comprising storing the digital collectible card on a server, and making the association of the digital collectible card with the user at the server.

6. The method of claim 1 or 5, wherein the association of the digital collectible card with the user indicates ownership of the digital collectible card by the user.

7. The method of claim 1, further comprising the step of notifying the user of a given digital collectible card associated with a second user wherein the given digital collectible card is available for purchase or trade.

8. The method of claim 1, comprising
keeping location information on mobile terminals in the communication network, and
determining the vicinity of a second user based on the location information of the mobile terminal of the user and of the mobile terminal of the second user.

9. The method of claim 1, and comprising before the step of associating the step of the user requesting to purchase the digital collectible card.

10. The method of claim 1, wherein the step of identifying the user in the communication network comprises the step of entering a password at the mobile terminal.

11. The method of claim 5, further comprising
transmitting a request from the mobile terminal to a server to send the digital collectible card to the mobile terminal,
identifying the user sending the request,
comparing the identity of the user having sent the request with the user identification information associated with the digital collectible card, and
providing the user with the digital collectible card in response to having determined a match of the identity and user identification information in the comparison.

12. The method of claim 11, wherein the step of providing the user with the digital collectible card comprises the steps of:
transmitting the digital collectible card from the server to the mobile terminal via the communication network; and
displaying the transferred digital collectible card on the mobile terminal.

13. The method of claim 11, wherein the step of providing the user with the digital collectible card comprises providing the digital collectible card for view on the mobile terminal for a limited period of time only.

14. The method of claim 1, wherein the digital collectible card includes at least one of a streamed video, an advertisement, digital music, a video clip and an avatar feature.

15. The method of claim 1, wherein the digital collectible card includes at least one dynamic user-specific feature.

16. The method of claim 1, wherein the digital collectible card comprises data information and the method further comprises the step of updating data information of the digital collectible card in real time based on a real event corresponding to the contents of the digital collectible card.

17. The method of claim 16, wherein the step of updating data information of the digital collectible card is done on request of the user.

18. The method of claim 1, further comprising the step of adding an indicator to the digital collectible card wherein the indicator includes a certain price for the digital collectible card.

19. The method of claim 1, wherein the communication network includes a cellular mobile communication network.

20. The method of claim 5, wherein the server storing a plurality of digital collectible cards and association information identifying the owners of the digital collectible cards.

21. A digital collectible card system in a communication network, comprising:
at least one mobile terminal for displaying and controlling of at least one digital collectible card associated with a user of the mobile terminal; and
a server communicating with the mobile terminal via the communication network for storing the digital collectible card and for associating the user with the digital collectible card.

22. The digital collectible card system of claim 21, further comprising
a digital physical card wirelessly communicating with the mobile terminal for, independently of the mobile terminal, presenting the digital collectible card transferred thereto.

23. The digital collectible card system of claim 21, wherein the communication network includes mobile network and Internet, and wherein the mobile network is selected from a group consisting of GSM, GPRS, and UMTS.

24. The digital collectible card system of claim 21, wherein the communication network includes a location register to locate the position of the mobile terminal.

25. The digital collectible card system of claim 21, wherein the digital collectible card includes at least one of a streamed video, an advertisement, digital music, a video clip and an avatar feature.

26. The digital collectible card system of claim 21, wherein the digital collectible card includes at least one dynamic user-specific feature.

27. A digital collectible card stored in an electronic memory and for display on a wireless mobile communication device, comprising:
first information for identifying the digital collectible card; and
second information representing a collectible object and being adapted to be displayed on a wireless mobile communication device.

28. A digital collectible card of claim 27, wherein the second information comprises at least one of a streamed video, an advertisement, digital music, a video clip, and an avatar feature.

29. A computer program product comprising a program of instructions executable by a computing system for administering digital collectible cards, comprising:
computer program code for identifying a user of a mobile terminal, the user entering a communication network using the mobile terminal; and
computer program code for associating a digital collectible card with the user based on the identification received from the mobile terminal.

30. A mobile terminal for viewing digital collectible cards, the mobile terminal comprising:
an input user interface to allow the user of the mobile terminal to input user identity information and to request a digital collectible card from the network;
a memory to store the digital collectible card received at the mobile terminal;
an output user interface to display a received digital collectible card;
a transceiver for wireless communication over the communication network; and
a processor configured to transmit user identity information to a digital collectible card server over the communication network and a request to receive a particular digital collectible card from the digital collectible card server.

31. A method for owning a digital collectible card to be displayed on a wireless user terminal, comprising the steps of:
storing a digital collectible card on a server;
associating at the server the digital collectible card with information indicating the owner of the card;
accessing the server with the wireless user terminal via wireless communication;
supplying identification information about the user of the wireless user terminal to the server; and
transferring the digital collectible card to the wireless user terminal having identified the user as the owner of the card.
